(19) United States
(12) Patent Application Publication
(10) Pub. No.: US 2008/0126926 A1
(43) Pub. Date: May 29, 2008

(54) HOST-BASED INFORMATION SYSTEM, CLIENT, HOST, INFORMATION SYSTEM, DISPLAY TERMINAL, AND CONTROL DEVICE

(75) Inventors: Fumio KOYAMA, Hara (JP); Yasuhito NAGATOMO, Hino (JP); Atsushi NARUSAWA, Hino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/553,529

(22) Filed: Oct. 27, 2006

(30) Foreign Application Priority Data
Oct. 31, 2005 (JP) 2005-316261
Aug. 31, 2006 (JP) 2006-236010

(51) Int. Cl. G06F 15/16; G06F 17/00

(52) U.S. Cl. 715/255; 709/203; 709/203

(57) ABSTRACT

A system including a plurality of clients and a host is provided. In the system, each client includes a storage-type display device holding a non-volatile display state; a unit storing data of a displayed document; client-side connection units that, when the host is connected, cause the client to communicate with the host and respectively correspond to predetermined processing; and a unit storing a response map indicating the predetermined processing corresponding to the client-side connection unit. The host includes a host-side connection unit which connects the host to the client-side connection unit; a unit obtaining data from the document storing unit, the data being displayed on the client display device set to communicate; and a unit executing predetermined processing on the obtained data, the processing being associated with the client-side connection unit, to which the host-side connection unit is connected, by the response map.

### RELATED APPLICATIONS

This application claims priority to Japanese Patent Application Nos. 2005-316261 filed Oct. 31, 2005 and 2006-236010 filed Aug. 31, 2006 which are hereby expressly incorporated by reference herein in their entirety.

### BACKGROUND

1. Technical Field

The present invention relates to a host-based information system composed of a plurality of clients and a host, to a client, to a host, to an information system, to a display terminal, and to a control device.

2. Related Art

Information devices have become smaller and less expensive and therefore more and more people manipulate a plurality of information devices. Soon, electronic paper is expected to be put to practical use and the realization of usability similar to conventional paper is expected. Therefore, it is desired to bridge a plurality of electronic paper devices.

When such a situation is provided, it is assumed that the respective electronic paper devices will be provided with a high-degree processing function and collaboration processing is performed by communication between the devices. In such an example, however, the respective devices are complex and expensive. Further, managing items such as communication and security are increased.

Subsequently, a host-based (thin client and server side) system is preferable in terms of cost and management. In the host-based type system, the respective electronic paper devices are specialized in the input and output of information, and a main function of information processing is focused on the host (server device). Such a host-based information system can be used in an enterprise resource planning application in a company and a large-scale network system such as information service of a mobile phone (for example, refer to JP-A-2003-157184).

In the host-based information system according to the related art, however, a web browser on a personal computer or mobile phone is assumed to be a client. Such a web browser is not necessarily suitable for a system in which a single user manipulates a plurality of clients, like a system composed of electronic paper devices. That is, the host-based information system according to the related art treats a client as a temporary input/output terminal. Therefore, like paper, while display data are held, it is difficult to deal with a manipulation assumed at the time of utilizing a plurality of clients. Such a manipulation includes keeping and leaving the display contents for a subsequent work by a user, or delivery to another user, like paper.

### SUMMARY

An advantage of some aspects of the invention is to provide a host-based information system, a client, a host, an information system, a display terminal, and a control device, which can be suitably applied to a system composed of electronic paper devices in which a single user manipulates a plurality of clients.

According to an aspect of the invention, a host-based information system composed of a plurality of clients and a host is provided. Each of the clients includes a storage-type display device that is capable of holding a display state in a non-volatile manner; a document storing unit that stores document data of a document displayed on the display device; a plurality of client-side connection units that, when the host is connected, cause the client to communicate with the host and respectively correspond to predetermined processing; and a response map storing unit that stores a response map indicating the predetermined processing corresponding to the client-side connection unit. The host includes a host-side connection unit that is capable of connecting the host to the client-side connection unit; a document data obtaining unit that obtains document data from the document storing unit, the document data being displayed on the display device of the client which is set to communicate; and a processing executing unit that executes predetermined processing on the document data obtained by the document data obtaining unit, the predetermined processing being associated with the client-side connection unit, to which the host-side connection unit is connected, by the response map.

According to another aspect of the invention, the host-side connection unit is used for indicating a position on the display device, the host is provided with a position detecting unit which detects a position indicated by the host-side connection unit, and the processing executing unit uses the positional information detected by the position detecting unit in the predetermined processing.

According to a further aspect of the invention, the client has an observed-side pattern written therein, the pattern indicating a position on the display device, the host-side connection unit detects the observed-side pattern written on an indicated position, and based on the detection result, the position detecting unit detects a position indicated by the host-side connection unit.

According to a still further aspect of the invention, the client includes a display data storing unit that stores display data generated based on the document data; and a display-state rewriting unit that rewrites a display state of the display device based on the display data stored in the display data storing unit, and the processing executing unit generates display data based on the document data obtained by the document data obtaining unit, as the predetermined processing, and stores the display data in the display data storing unit of the corresponding client.

According to a still further aspect of the invention, the host includes a response map generating unit that generates the response map; and a response map rewriting unit that rewrites a response map, stored in the response map storing unit of the client which is set to communicate, into a response map generated by the response map generating unit.

According to a still further aspect of the invention, the host includes a response map generating unit that generates a response map based on the document data obtained by the document data obtaining unit; and a response map rewriting unit that rewrites a response map, stored in the response map storing unit of the client which is set to communicate, into the response map generated by the response map generating unit. After the response map rewriting unit rewrites the response map, the display state rewriting unit starts to rewrite a display state of the display device.

According to a still further aspect of the invention, the client receives electric power from a power supply of the host so as to operate.

According to a still further aspect of the invention, there is provided a client in a host-based information system composed of a plurality of clients and a host. The client includes a storage-type display device that is capable of holding a display state in a non-volatile manner; a document storing unit that stores document data of a document displayed on the display device; a plurality of client-side connection units that, when the host is connected, cause the client to communicate with the host and respectively correspond to predetermined processing; and a response map storing unit that stores a response map indicating the predetermined processing corresponding to the client-side connection unit.

According to a still further aspect of the invention, there is provided a host in a host-based information system composed of a plurality of clients and a host. The host includes a host-side connection unit that connects the host to a predetermined position of the client so as to cause the client and host to communicate with each other; a document data obtaining unit that obtains document data from the client, the document data being displayed on the display device of the client which is set to communicate; and a processing executing unit that executes predetermined processing on the document data obtained by the document data obtaining unit, the predetermined processing being associated with the predetermined position, to which the host-side connection unit is connected.

According to a still further aspect of the invention, there is provided an information system composed of a display terminal and a control device. The display terminal includes a storage-type display device that is capable of holding a display state in a non-volatile manner; a document storing unit that stores document data of a document displayed on the display device; a display terminal-side connection unit that, when the control device is connected, causes the display terminal to communicate with the control device; a display data storing unit that stores display data generated on the basis of the document data; and a display state rewriting unit that rewrites a display state of the display device based on the display data stored in the display data storing unit. The control device includes a control device-side connection unit that is capable of connecting the control device to the display terminal-side connection unit; a document data obtaining unit that obtains document data from the document data storing unit, the document data being displayed on the display device of the display terminal which is set to communicate; and a processing executing unit that generates display data based on the document data obtained by the document data obtaining unit and executes display data storage processing in which the display data is stored in the display data storing unit of the display terminal.

According to a still further aspect of the invention, the plurality of display terminal-side connection units are provided so as to respectively correspond to predetermined processing, the display terminal includes a response map storing unit that stores a response map indicating the predetermined processing corresponding to the display terminal-side connection unit; the response map includes the display data storage processing as the predetermined processing, and the processing executing unit executes the predetermined processing on the document data obtained by the document data obtaining unit, the predetermined processing being associated with the display terminal-side connection unit, to which the control device-side connection unit is connected, by the response map.

According to a still further aspect of the invention, a display terminal includes a storage-type display device that is capable of holding a display state in a non-volatile manner; a document storing unit that stores document data of a document displayed on the display device; a display terminal-side connection unit that, when a control device composing an information system along with said display terminal is connected, causes the control device and the display terminal to communicate with each other; and a display state rewriting unit that rewrites a display state of the display device based on the display data stored in the display data storing unit.

According to a still further aspect of the invention, a control device includes a control device-side connection unit that is capable of connecting the control device to a predetermined position of a display terminal composing an information system along with said control device; a document data obtaining unit that obtains document data of a document from the display terminal, the document being displayed on the display device of the display terminal which is set to communicate; and a processing executing unit that generates display data on the basis of the document data obtained by the document data obtaining unit and executes processing in which the display data is stored in the display terminal.

According to such a construction, while display data are held, suitable processing can be executed based on the response map stored in the client by connecting the host-side connection unit to the client-side connection unit, even though a manipulation assumed at the time of utilizing a plurality of clients is made. Such a manipulation includes keeping and leaving the display contents for a subsequent work by a user, or a delivery to another user, like paper. Further, while referring to the document storing unit and the response map, it is possible to recursively advance a processing procedure.

### BRIEF DESCRIPTION OF THE DRAWINGS

The invention will be described with reference to the accompanying drawings, wherein like numbers reference like elements.

FIG. 1 is a diagram illustrating a host-based information system according to a first embodiment.

FIG. 2 is a flow chart illustrating computation executed by a host of FIG. 1.

FIG. 3 is a flow chart illustrating computation executed by the host and a client of FIG. 1.

FIG. 4 is a diagram illustrating a host-based information system according to a second embodiment.

FIG. 5 is a diagram illustrating a host-based information system according to a third embodiment.

### DESCRIPTION OF EXEMPLARY EMBODIMENTS

Hereinafter, a preferred embodiment of the invention, in which a host-based information system is applied to an information system having a plurality of clients capable of switching and displaying contents, will be described with reference to the drawings.

### First Embodiment

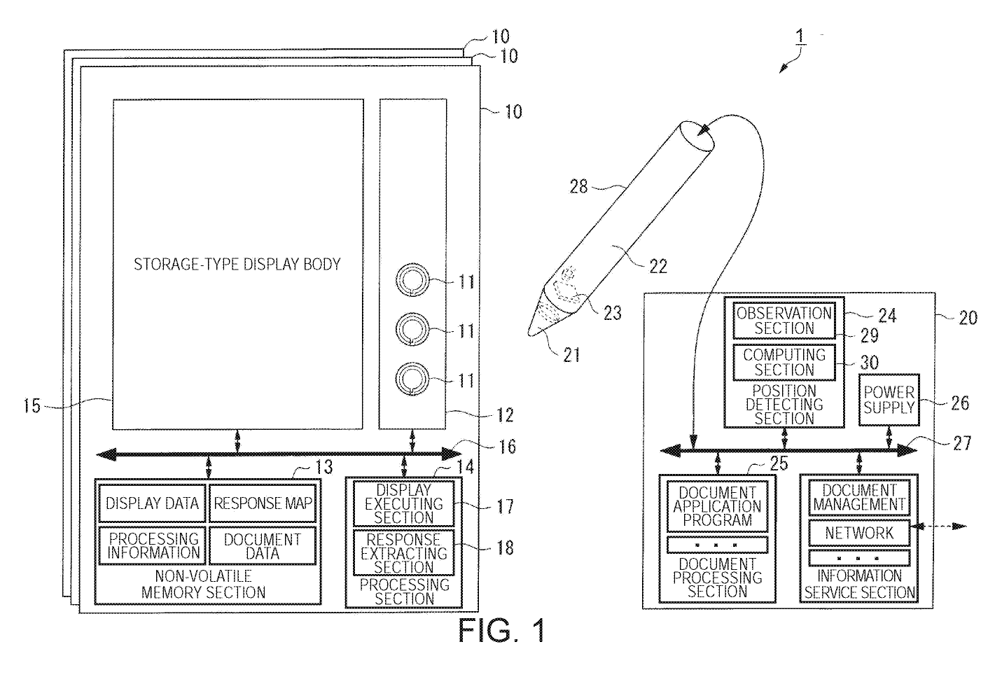

FIG. 1 is a diagram illustrating an exterior construction of an information processing system 1 according to a first embodiment of the invention. As shown in FIG. 1, the information processing system 1 includes a plurality of clients 10 having a slim shape like paper and a host 20 having a pen-shaped manipulation indicating section.

### Construction of Client

The client 10 includes an indication connection section 11, a connection control section 12, a non-volatile memory section 13, a processing section 14, and a storage-type display body 15, which are connected so as to communicate with each other through a bus 16.

The indication connection section 11 is an interface for inputting and outputting information and electric power between the client 10 and the host 20.

Specifically, the indication connection section 11 is provided with an antenna coil for inputting and outputting electric power and information in response to the input of different indications. The antenna coil is electromagnetically coupled to an antenna coil provided in an indication connection section 21 (to be described below) of the host 20, so that the indication connection section 11 receives power from the host 20 so as to operate. Further, the indication connection section 11 receives information superimposed on an induction field and modulates a return carrier wave caused by induction into information to be transmitted, thereby inputting and outputting information with the host 20.

As for information which is input and output between the client 10 and the host 20, there can be exemplified document data of contents to be displayed, display data, a response map, coordinates of a portion touched by the leading end of a manipulation indicating section 28 (to be described below) of the host 20, a display state of various processes and the like.

The response map is a map for displaying execution indications associated with the respective indication connection sections 11 or document elements or interaction elements (character string, image, link information, and execution instruction) which are displayed on the respective coordinates of the storage-type display body 15.

In this embodiment, by the response map, the indication connection section 11 positioned on the uppermost stage of FIG. 1 is associated with an execution indication of the movement to the next page, and the indication connection section 11 positioned on the second stage is associated with an execution indication of the extraction of character string.

The connection control section 12 controls the input and output of information and electric power which is performed through the indication connection section 11. In other words, the connection control section 12 extracts operation power by rectifying the input from the indication connection section 11 indicated and activated by the indication connection section 21 of the host 20, that is, from the indication connection section 11 in which induction power is generated. Further, the connection control section 12 discriminates the activated indication connection section 11 through a comparator circuit or the like and then executes a client protocol by predetermined serial data, which is input and output between the client 10 and the host 20, through the indication connection section 11. In this manner, the connection control section 12 manages the input and output to the non-volatile memory section 13 or the processing section 14. Further, as will be described below, a connection control section 22 of the host 20 performs communication using a corresponding host protocol. Then, the client 10 and the host 20 are connected to each other such that input and output can be performed. At this time, the discrimination result on the activated indication connection section 11 can be referred to from the connected host 20.

The non-volatile memory section 13, composed of non-volatile memory such as flash memory, stores information (document data of contents, display data, and a response map) input from the host 20 through the indication connection section 11 or states of various processing steps performed by the host 20.

The processing section 14 includes a display executing section 17 and a response extracting section 18.

When display data stored in the non-volatile memory section 13 is updated, the display executing section 17 directly controls the storage-type display body 15 so as to display the updated display data on the storage-type display body 15. Specifically, the display executing section 17 drives an X driver and Y driver of the storage-type display body 15 by referring to display data stored in the non-volatile memory section 13. Then, a raster graphic to be drawn is displayed on the storage-type display body 15. Moreover, as for a method of driving the storage-type display body 15, for example, a passive matrix driving method, a TFT (Thin Film Transistor) driving method, and a D-TFD (Digital Thin Film Diode) driving method can be adopted.

When the discrimination result of the activated indication connection section 11 or an inquiry on coordinates of a portion touched by the leading end of the manipulation indicating section 28 is input from the host 20, the response extracting section 18 extracts data on an execution instruction associated with the corresponding indication connection section 11 from the response map and the document data stored in the non-volatile memory section 13 or document or interact elements displayed on the storage-type display body 15. Then, the response extracting section 18 outputs the extraction result to a document processing section 25 (to be described below) of the host 20 through the indication connection sections 11 and 21 and the connection control section 22.

The storage-type display body 15 is composed of an A4-sized display device with high pixel density. In accordance with the control of the display executing section 17, the storage-type display body 15 displays pixel data on predetermined pixels so as to display a raster graphic. As for the storage-type display body 15, for example, an electrophoretic display, a cholesteric liquid crystal display, a display using charged toner, a display using twist balls, or an electro-deposition display can be adopted.

On the surface of the storage-type display body 15, a coordinate pattern composed of information graphics indicating coordinates on the surface is formed so as to be observed from the host 20, thereby providing coordinates of an indicated position to the host 20, which will be described below.

### Construction of Host

The host 20 includes an indication connection section 21, a connection control section 22, a position detecting section 24, a document processing section 25, an information service section, and a power supply 26, which are connected so as to communicate with each other through a bus 27.

The indication connection section 21, provided on the leading end of the manipulation indicating section 28, is an interface for inputting and outputting information and electric power between the client 10 and the host 20. Specifically, the indication connection section 21 is provided with an antenna coil for inputting and outputting electric power and information and is electromagnetically coupled to the antenna coil provided in the indication connection section 11 of the client 10 so as to input and output information and electric power between the client 10 and the host 20.

The connection control section 22 controls the input and output of information and electric power which is performed through the indication connection section 21. That is, the connection control section 22 applies to the antenna coil an alternating current including a control signal based on power from the power supply 26 so as to induce the antenna coil of the indication connection section 11 of the client 10. Further, the connection control section 22 controls execution of a host protocol for predetermined serial data that is input and output between the client 10 and the host 20 through the indication connection section 21, thereby managing the input and output of the document processing section 25.

When the leading end of the manipulation indicating section 28 is touched on the client 10, an infrared light emitting and receiving section 23 irradiates infrared light on the touched portion and receives the reflected light. Then, the infrared light emitting and receiving section 23 outputs the light reception result to the position detecting section 24. As for a method of detecting whether the leading end of the manipulation indicating section 28 is touched on the client 10 or not, for example, a method in which a switch is provided in the leading end of the manipulation indicating section 28 or an electromagnetic method can be adopted.

The position detecting section 24 includes an observation section 29 and a computing section 30.

The observation section 29 detects a coordinate pattern of a portion touched by the manipulation indicating section 28, based on the light reception result output from the infrared light emitting and receiving section 23. Then, the observation section 29 outputs the detection result to the computing section 30.

The computing section 30 computes coordinates indicated by the detection result (coordinate pattern) output from the observation section 29 by decoding an information graphic. Then, the computing section 30 provides the coordinates to the document processing section 25.

The document processing section 25 controls the overall information processing system 1. In accordance with various process executing indications extracted from the client 10 through the indication connection section 21, the document processing section 25 reads and executes corresponding processing routines which are previously stored. Specifically, an execution indication for displaying the next page of a document which is being displayed is executed by the following series of stored processing routines. First, information (processing information) related to the page which is being displayed on the storage-type display body 15 and document data are obtained from the non-volatile memory section 13 through the indication connection sections' 11 and 21 and the connection control section 22, lay-out processing of the next page is executed on the basis of the processing information and the document data, and display data of the next page and a response map are created so as to be stored in the non-volatile memory section 13 through the indication connection sections 11 and 21 and the connection control section 12.

Further, an execution indication for extracting a display character string indicated from a document which is being displayed is executed by the following series of stored processing routines. First, coordinates (coordinates of start and end points of a character string to be extracted) which are previously indicated by a user are obtained from the operation section 30, document elements displayed on the coordinates are inquired to the response extracting section 18, and character string data extracted as an output from the response extracting section 18 is temporarily held.

The power supply 26 composed of a primary or secondary battery supplies electric power to the respective sections (the indication connection sections 21 of the host 20) of the information processing system 1.

### Operation of Information Processing System

Next, the operation of the information processing system of this embodiment will be described.

### Basic Operation

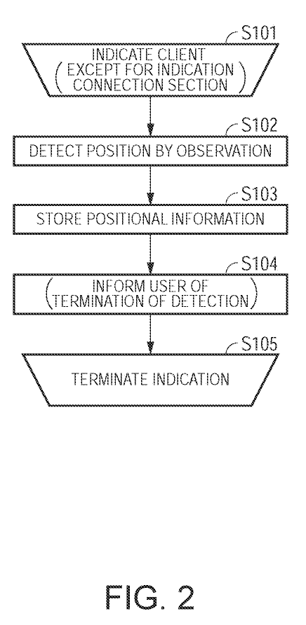

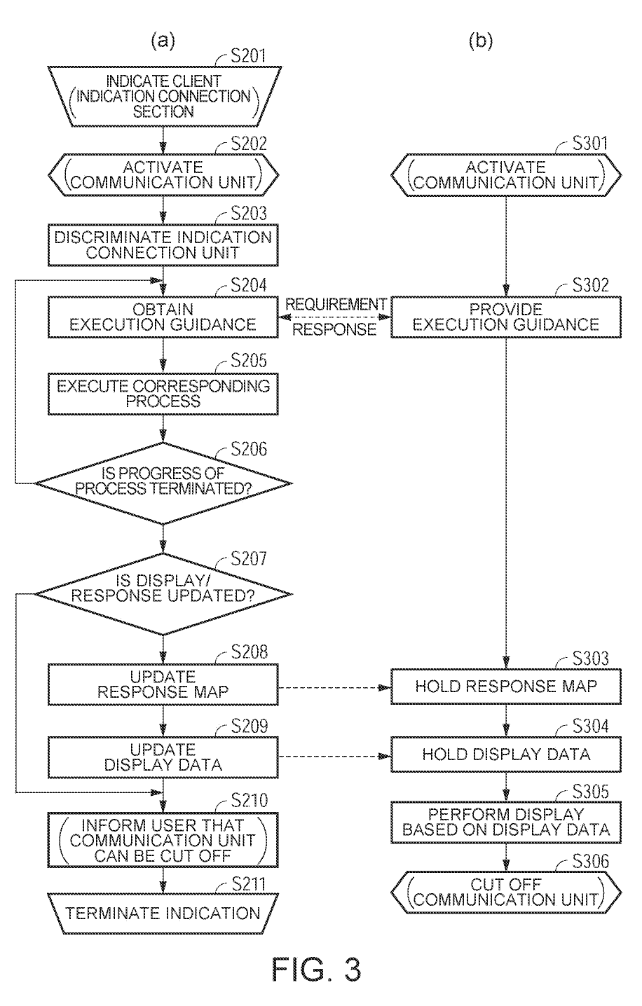

The information processing system of this embodiment operates in accordance with basic procedures shown in FIGS. 2, 3A, and 3B. The contents of processing are determined correspondingly to the discrimination results of the indication connection section 11 by using coordinates which are computed by the host 20 on the basis of a coordinate pattern.

The entire processing starts when the host 20 indicates the client 10.

Here, the processing can be divided into two cases by whether a portion indicated by the host 20 is the indication connection section 11 of the client 10 or not. The individual cases can be judged by whether communication is activated through the indication connection section 11 or not. That is, when it is detected that the leading end of the manipulation indicating section 28 is touched, the host 20 causes the connection control section 22 to apply an alternating current including a control signal to the antenna coil, based on power from the power supply 26. At this time, when the coil of the indication connection section 21 is electromagnetically coupled to the coil provided in the indication connection section 11 of the client 10, connection is also detected in the indication connection section 21 of the host 20, based on a change in impedance or an initial response to the client protocol. In the meantime, if the indication connection sections 11 and 21 are not close to each other in a predetermined range, a change in impedance or an initial response is not generated, and connection is not detected.

When connection is not detected within a predetermined time, the host 20 independently performs processing, as shown in FIG. 2. On the other hand, when connection is detected, the host 20 and the client 10 perform processing in collaboration with each other while communicating with each other, as shown in FIGS. 3A and 3B.

First, a case where the other sections excluding the indication connection section 11 are indicated will be described with reference to FIG. 2. In this case, although a user touches the client 10 by using the leading end of the manipulation connection section 28 and the connection control section 22 of the host 20 applies an alternating current including a control signal to the antenna coil, communication is not activated (Step S101).

In this case, the host 20 executes only position detection and storage thereof. That is, the host 20 causes the infrared light emitting and receiving section 23 to irradiate infrared light on the surface of the client 10 indicated by the leading end of the manipulation connection section 28 and to receive the reflected light. Then, the light reception result is output to the observation section 29. Further, the observation section 29 outputs a coordinate pattern of the indicated position as a detection result to the computing section 30, based on the output light reception result. The computing section 30 computes coordinates indicated by the coordinate pattern, and the computed results are sequentially stored (Steps S102 and S103). If such procedures are terminated, the host 20 drives a vibrator (not shown) or the like so as to inform the user of the termination of detection (Step S104). Then, processing and indication manipulation are terminated (Step S105).

Next, a case where the indication connection section 11 is indicated will be described with reference to FIGS. 3A and 3B. In this case, when a user touches the indication connection section 11 of the client 10 by using the leading end of the manipulation indicating section 28 (Step S201) and the connection control section 22 of the host 20 applies an alternating current including a control signal to the antenna coil, communication with the indication connection section 11 is activated (Steps S202 and S301). Here, the activated indication connection section 11 is discriminated based on the above description (Step S203), and the host 20 obtains the code thereof. Accordingly, the document processing section 25 inquires a processing execution instruction corresponding to the indication connection section 11 to the response extracting section 18.

Then, the response extracting section 18 extracts a corresponding processing execution indication from the response map, based on the inquiry. The extraction result is output to the document processing section 25 through the connection control section 12 and the indication connection sections 11 and 21 (Step S302), and a corresponding processing routine starts to be executed by the document processing section 25 (Step S204).

As described above, the processing based on the processing execution indication is executed by the document processing section 25. Typically, the processing is performed on a document which is being displayed. The document processing section 25 obtains information (processing information) related to the processing course of the document, which is being displayed on the storage-type display body 15, and document data from the non-volatile memory section 13 through the indication connection sections 11 and 21 and the connection control section 22. Further, the document processing section 25 performs processing based on the processing information and the document data (Step S205).

In the executed processing, data on the results of coordinate detection are used, the data being sequentially stored in the host 20. For example, after sequentially indicating document elements related to the processing on the storage-type display body 15, a user touches the indication connection section 11 so as to indicate processing contents. In the processing of coordinate data, the document processing section 25 inquires about searching information corresponding to the response extracting section 18 and refers to document elements output as a result. That is, in the processing executed by the document processing section 25, when the document element which is being displayed on the previously-indicated coordinates is set to a target to be processed, the document processing section 25 refers to the previously indicated coordinates from the stored coordinate detection data and inquires to the response extracting section 18 what is a document element displayed on the corresponding position on the basis of the coordinates. Based on the inquiry, the response extracting section 18 extracts a corresponding document or interaction element from the response map stored in the non-volatile memory section 13 and returns the extraction result to the document processing section 25.

As for results of processing related to such a document which is being displayed, various results are considered. If they are generalized, some changes are generated in a display state through processing. Further, when a display state is changed, response processing to be executed on indication is also updated. That is, the document processing section 25, if necessary, outputs the updated response map and display data as results of processing. The output display data and response map are stored in the non-volatile memory section 13 through the indication connection sections 21 and 11 and the connection control section 12 (Steps S206, S207, S208, S209, S303, and S304). At this time, the display executing section 17 sequentially displays the display data stored in the non-volatile memory section 13 on the storage-type display body 15 (Step S305).

When such procedures are terminated, the host 20 drives a vibrator (not shown) so as to inform the user of the termination of detection (Step S210). Then, processing and indication manipulation are terminated (Steps S211 and S306).

### Page Turning Operation

As a specific processing example according to the above-described basic operation, a page turning operation will be described. This operation is executed in accordance with a manipulation in which a user indicates the indication connection section 11 to designate the movement into the next page or a manipulation in which a user indicates the indication connection section 11 to designate the movement into the previous page. Hereinafter, a case will be described, in which a user touches the uppermost indication connection section 11 of FIG. 1, to which the movement into the next page is allocated, by using the leading end of the manipulation instruction section 28.

In this example, communication is activated on the basis of the above descriptions as shown in FIGS. 3A and 3B, in order to indicate the indication connection section 11 (Steps 201, 202, and 301). The activated indication connection section 11 is discriminated based on the above description (Step S203), and the host 20 obtains the code thereof. Continuously, the document processing section 25 inquires a processing execution indication corresponding to the indication connection section 11 to the response extracting section 18.

Then, the response extracting section 18 extracts a corresponding processing execution instruction from the response map, based on the inquiry. In this example, an execution indication for displaying the next page is extracted, and the extraction result is output to the document processing section 25 through the connection control section 12 and the indication connection sections 11 and 21 (Step S302). Further, the document processing section 25 executes a corresponding processing routine (Steps S204 and S205). By this processing routine, information (processing information) related to a page which is being displayed on the storage-type display body 15 and document data are obtained from the non-volatile memory section 13 through the indication connection sections 11 and 21 and the connection control section 22, lay-out processing of the next page is executed based on the processing information and document data, and the response map of the next page is created so as to be stored in the non-volatile memory section 13 through the indication connection sections 11 and 21 and the connection control section 12 (the response map is rewritten). Further, after the response map is rewritten, display data of the next page is created so as to be stored in the non-volatile memory section 13 through the indication connection sections 11 and 21 and the connection control section 12 (Steps S206, S207, S208, S209, S303, and S304).

Then, the display executing section 17 displays the display data stored in the non-volatile memory section 13 on the storage-type display body 15 (Steps S305, S210, S211, and S306).

When this processing is performed, a procedure for the element extraction from coordinates is not needed.

### Operation for Extracting Character String

As another specific processing example according to the basic operation, an operation for extracting a character string will be described. This operation is executed in accordance with the following series of manipulations. First, a user sequentially indicates the start and end points of a displayed character string which is desired to be extracted. Then, the user indicates the indication connection section 11 for designating the extraction of character string.

First, in order to designate a character string to be extracted, a user touches the start point (the storage-type display body 15) of the character string to be extracted by using the leading end of the manipulation indicating section 28. In this case, communication is not activated as shown in FIG. 2 (Step S101). Accordingly, the infrared light emitting and receiving section 23 irradiates infrared light on the touched pixel and receives the reflected light. Then, the light reception result is output to the observation section 29. Then, based on the output light reception result, the observation section 29 outputs a coordinate pattern of the pixel as a detection result to the computing section 30. The computing section 30 computes coordinates indicated by the coordinate pattern, and the computed result is stored (Steps S102 and S103). Then, the procedure is terminated (Steps S104 and S105).

Similarly, if a user touches the end point of a character string to be extracted by using the leading end of the manipulation indicating section 28, communication is not activated as shown in FIG. 2 (Step S101). The coordinates of the end point is stored in the computing section 30 by the infrared light emitting and receiving section 23, the observation section 29, and the computing section 30, and the procedure is terminated (Steps S102 to S105).

Finally, if the user touches the second indication connection section 11 of FIG. 1, to which the execution of character string extraction is allocated, by using the leading end of the manipulation indicating section 28, communication is activated the same as the page turning operation by the indication connection section 11, as shown in FIGS. 3A and 3B (Steps S201, S202, and S301). The activated indication connection section 11 is discriminated based on the above description (Step S203), and the host 20 obtains the code thereof. Continuously, the document processing section 25 inquires a processing execution indication corresponding to the indication connection section 11 to the response extracting section 18.

Then, based on the inquiry, the response extracting section 18 extracts a corresponding processing execution indication from the response map. In this example, an execution indication for extracting a character string is extracted, and the extraction result is output to the document processing section 25 through the connection control section 12 and the indication connection sections 11 and 21 (Step S302), and the document processing section 25 executes a corresponding processing routine (Steps S204 and S205). As the document processing section 25 executes the processing routine, the sequentially designated coordinates are obtained from the computing section 30, a document element displayed on the coordinates is inquired to the response extracting section 18, and character string data which is extracted as an output from the response extracting section 18 is stored in the host 20. Then, the procedure is terminated (Steps S206 to S211, S303, and S304 to S306). The extraction of document element is realized by any one of the following methods. A first method is where a reference indication of document data is described in the response map such that the response extracting section 18 performs extraction by referring to the document data. A second method is where an extraction indication is described in the form according to the document element within the response map such that the response extracting section 18 performs extraction without referring to document data. When this processing is performed, the display data or response map is not updated.

(1) As such, the information processing system 1 of this embodiment executes the following processing routine. First, document data or response map is stored in the client 10, the document data displayed on client 10 which is set to communicate is obtained from the client 10, and the document data is associated with the indication connection section 11, which is being touched by the leading end of the manipulation indicating section 28, through the response map. Therefore, while display contents are held, suitable processing can be executed based on the response map stored in the client 10 by indicating the indication connection section 11 of the client 10 through the manipulation indicating section 28, even though a manipulation assumed at the time of utilizing a plurality of clients 10 is made. Such a manipulation includes keeping and leaving the display contents for a subsequent work by a user, or a delivery to another user, like paper. Therefore, while the processing state or document data is referred to, it is possible to recursively advance the processing procedure.

For example, as the client 10 is delivered to another user, any problem does not occur, even though the host 20 executing processing changes. Further, transfer/loan into another user is easily performed.

Further, the response extracting section 18 of the client 10 extracts an execution indication or document data from the response map and document data, and then transmits the extraction result to the host 20. Therefore, it is possible to effectively execute response extraction processing through the indication connection sections 11 and 21.

(2) The indication position of the manipulation indicating section 28 is detected, and the operation for extracting a character string is performed based on the detection result. Therefore, as a displayed character string which is desired to be extracted is indicated by the manipulation indicating section 28, it is possible to execute suitable processing based on the character string.

(3) The observation section 29 of the host 20 detects a coordinate pattern printed on the indication position of the manipulation indicating section 28, and the computing section 30 of the host 20 detects the coordinates based on the detection result. Therefore, the client 10 does not need to operate actively at all. Further, it is possible to provide an extremely inexpensive system, which makes it possible to promote the usage of a plurality of systems.

(4) Based on the display data stored in the non-volatile memory section 13 of the client 10, the display state of the storage-type display body 15 is rewritten into the display executing section 17 of the client 10. Therefore, the client 10 can perform rewriting of the storage-type display body 15 thereof, and display can be effectively executed through the indication connection sections 11 and 21.

(5) The response map stored in the non-volatile memory section 13 of the client 10 which is set to communicate can be rewritten into a response map created by the host 20. Therefore, based on the response map stored in the client 10, suitable processing can be executed.

(6) After the response map stored in the non-volatile memory section 13 is rewritten, the display state of the storage-type display body 15 of the client 10 starts to be rewritten. Therefore, while the display state is being rewritten, a user who has seen a portion of the rewritten display contents can execute suitable processing according to the intention of the user without waiting for the termination of rewriting, when the manipulation indicating section 28 newly indicates the indication connection section 11 in accordance with the display contents.

(7) Electric power is supplied from the power supply 26 of the host 20 so as to operate the client 10. Therefore, the host 20 can communicate with or operate only the required client 10 without a preliminary connection manipulation, which makes it possible to exclude wasteful procedures.

In this embodiment, it is shown that all the display data and response map created by the host 20 are output to the client 10. However, the embodiment is not limited thereto. For example, only a changed portion of the display data or response map may be output to the client 10. Then, an amount of information which is output to the client 10 from the host 20 can be preferably reduced.

Specifically, the display data is created by separating the previously created display data and updated data, only the update data is output to the client 10 from the host 20, and only the updated data is sequentially added to the non-volatile memory section 13 of the client 10. Further, based on the updated data, the display executing section 17 partially drives the storage-type display body 15 (rewriting).

Further, the updated data is reflected into the display data stored in the non-volatile storage section 13, and the entire storage-type display body 15 may be driven based on the display data reflecting the updated data.

The response map is created by parting the previously created response map and an updated map, only the updated map is output to the client 10 from the host 20, and only the updated map is sequentially added to the non-volatile memory section 13 of the client 10. Further, when the extraction of character string is performed by the document processing section 25, the most recently updated map is preferentially used.

Further, the updated map is reflected into the response map stored in the client 10 (updating), and the entire response map after updating may be used.

As described above, whether the indication connection section 11 is indicated or not can be judged by using another method. For example, the same coordinate pattern as on the surface of the storage-type display body 15 is provided on the indication connection section 11. The host 20 obtains coordinates. When the coordinates are present in a predetermined range, the host 20 judges that the indication connection section 11 is indicated, and then starts communication. In this case, coil induction does not need to be attempted for each indication, which makes it possible to realize electric power saving.

Even when it is judged that the indication connection section 11 is indicated, the coordinates obtained by the coordinate pattern can be used in processing. For example, when the area of the indication connection section 11 is larger than that of the leading end of the indication connection section 21, an indication position of the indication connection section 11 within the range may be discriminated finely.

In this embodiment, it is shown that only necessary information is extracted and output by the response extracting section 18 of the client 10. However, the embodiment is not limited thereto. For example, the entire response map as well as the document data may be output from the client 10 so as to extract information necessary for the host 20. At this time, in order to prepare when the same client 10 is continuously processed, the document data or response map may be cached by the host 20 so as to be held under a predetermined condition.

### Second Embodiment

Now, a host-based information system according to a second embodiment of the invention will be described.

The second embodiment is different from the first embodiment in that the input and output of information between the client 10 and the host 20 is performed by using infrared light instead of a coil.

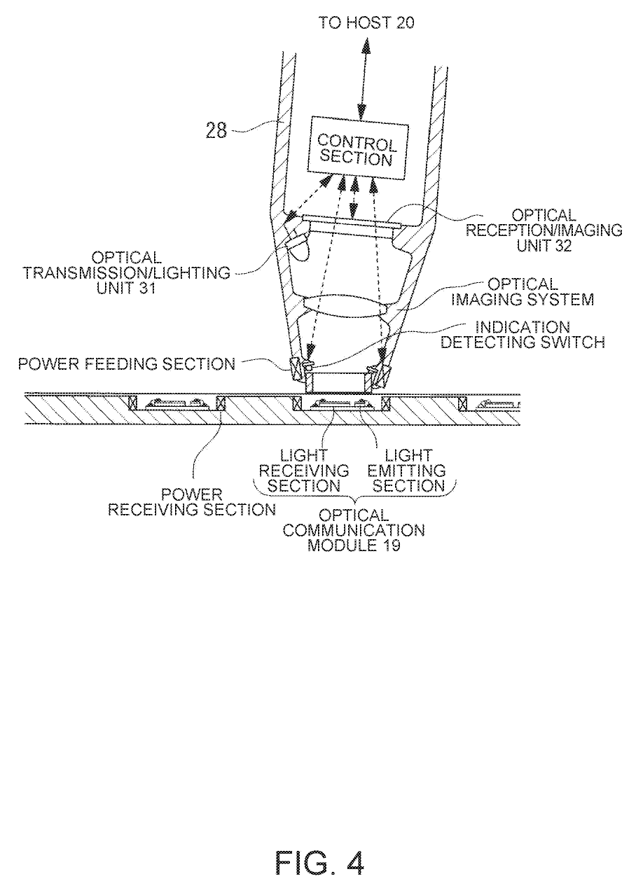

Specifically, the indication connection section 11 of the client 10 is provided with an infrared light receiving and emitting section (optical communication module 19) instead of a coil for inputting and outputting information, as shown in FIG. 4. Further, the indication connection section 21 of the host 20 is provided with an infrared light receiving and emitting section (a light emitting section=optical transmission/lighting unit 31 and a light receiving section=optical reception/imaging unit 32) instead of a coil for inputting and outputting information.

Similar to the first embodiment, the indication connection sections 11 and 21 are provided with a coil (an electromagnetic coupling section (power feeding section and power receiving section) for feeding power) for transmitting and receiving power.

In the information processing system 1 of this embodiment, the input and output of information between the client 10 and the host 20 is performed by infrared light. Therefore, high-speed (16 Mbps or the like) communication can be performed at low power. Further, even when the electromagnetic coupling section is provided so as to feed power to the client 10, the influence on communication is extremely small. Further, when the optical transmission/lighting unit 31 and the optical reception/imaging unit 32 are used together in a light or imaging section of the infrared light receiving and emitting section 23 for optically reading a coordinate pattern (position information code) of the client 10, the number of parts and the cost can be reduced, and the manipulation indication section 28 can be reduced in size.

### Third Embodiment

Now, a host-based information system according to a third embodiment of the invention will be described.

In a host-based information system according to the related art, the host 20 is generally present in a remote place. Further, since the host 20 simultaneously performs a plurality of processes through multitask/multithread processing, displaying information of a specific client 10 is not performed.

However, the host 20 is present near the client 10, and the client 10 to be processed is switched by relatively rough time grading operation such as pointing the client 10. Therefore, it is preferable that the host 20 can present information about specific processing on itself.

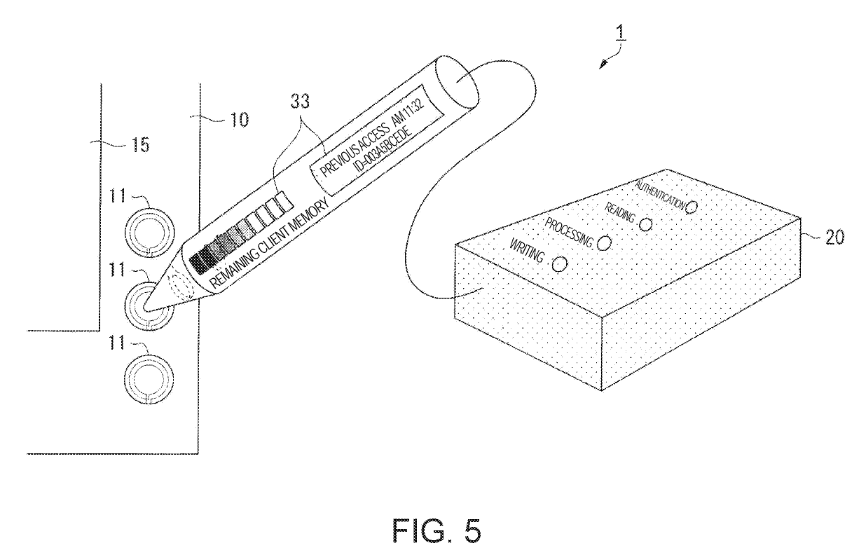

In the third embodiment, an information display section 33 is provided in the manipulation indicating section 28 of the host 20, as shown in FIG. 5. The information display section 33 displays a discrimination ID of the client 10 which is being touched by the leading end of the manipulation indicating section 28. Therefore, when the plurality of clients 10 is used, it is useful for the user to perform a checking operation. A method of discriminating the clients 10 can be implemented by setting a different ID to each of the clients 10, the ID being used for the discrimination of the coordinate pattern or indication connection sections 11. Further, when communication is performed, a station ID may be imparted so as to be exchanged.

When a transfer state of display data or response map to the client 10 or a transfer direction (from the host 20 to the client 10 or from the client 10 to the host 20) is displayed on the information display section 33, it is helpful to grasp a promoted state of manipulation performed by a user, and it is possible to prevent an unintentional manipulation (for example, the leading end of the manipulation indicating section 28 is separated from the client 10 while transfer is performed). Further, when information on what time the previous processing is performed is displayed in relation with the client 10 which is being manipulated, it is useful to grasp and recollect a manipulation history.

A request to display such information is unsuitable for the storage-type display body 15, because it is generated for a short time. In the host 20, however, such a problem does not occur, and thus the request to display such information is suitable.

In this embodiment, it is shown that the information display section 33 is provided in the manipulation indication section 28 of the host 20. Without being limited thereto, however, the information display section 33 may be provided in the main body of the host 20.

In the above-described embodiment, the storage-type display body 15 of FIG. 1 composes a display unit in the claims of the invention. Similarly, the non-volatile memory section 13 of FIG. 1 composes a document storing unit, a response map storing unit, and a display data storing unit; the indication connection section 11 of FIG. 1 composes a client-side connection unit; the manipulation indication section 28 of FIG. 1 composes a host-side connection unit; the position detecting section 24, the observation section 29, and the computing section 30 of FIG. 1 compose a position detecting unit; the document processing section 25 of FIG. 1 composes a document data obtaining unit; the document processing section 25 of FIG. 1 composes a processing executing unit; and the processing section 14 and the display executing section 17 of FIG. 1 compose a display state rewriting unit.

The host-base information system, the client, the host, the information system, the display terminal, and the control device are not limited to the above-described embodiments, but can be suitably modified without departing from the scope of the invention.

For example, in the host-based system according to the related art, it has been expected that the client 10 has such a function as an independent network terminal. Accordingly, each client 10 needs to have a relatively high-degree independent function such as a user-interface processing function or network terminal function, which makes it impossible to sufficiently reduce the manufacturing cost and managing cost.

Therefore, an available information service (data store and network communication) may be provided from the document processing section 25 of the host 20. Then, the application of the document processing section 25 can easily perform various and high-degree processes.

What is claimed is:

1. A host-based information system comprising:
a plurality of clients; and
a host;
wherein each of the plurality of clients includes:
a storage-type display device adapted to hold a display state in a non-volatile manner;
a document storing unit that stores document data of a document displayed on the display device;
a plurality of client-side connection units that, when the host is connected, cause the client to communicate with the host and respectively correspond to predetermined processing; and
a response map storing unit that stores a response map indicating the predetermined processing corresponding to the client-side connection unit, and
the host includes:
a host-side connection unit adapted to connect the host to the client-side connection unit;
a document data obtaining unit that obtains document data from the document storing unit, the document data being displayed on the display device of the client which is set to communicate; and
a processing executing unit that executes predetermined processing on the document data obtained by the document data obtaining unit, the predetermined processing being associated with the client-side connection unit, to which the host-side connection unit is connected, by the response map.

2. The host-based information system according to claim 1, wherein:
the host-side connection unit indicates a position on the display device;
the host is provided with a position detecting unit which detects a position indicated by the host-side connection unit; and
the processing executing unit uses the positional information detected by the position detecting unit in the predetermined processing.

3. The host-based information system according to claim 2, wherein:
the client has an observed-side pattern written therein, the pattern indicating a position on the display device;
the host-side connection unit detects the observed-side pattern written on an indicated position; and
based on the detection result, the position detecting unit detects a position indicated by the host-side connection unit.

4. The host-based information system according to claim 1, wherein:
the client includes:
a display data storing unit that stores display data generated based on the document data; and
a display-state rewriting unit that rewrites a display state of the display device based on the display data stored in the display data storing unit; and
the processing executing unit generates display data based on the document data obtained by the document data obtaining unit, as the predetermined processing, and stores the display data in the display data storing unit of the corresponding client.

5. The host-based information system according to claim 1, wherein the host includes:
a response map generating unit that generates the response map; and
a response map rewriting unit that rewrites a response map, stored in the response map storing unit of the client which is set to communicate, into a response map generated by the response map generating unit.

6. The host-based information system according to claim 1, wherein the host includes:
a response map generating unit that generates a response map based on the document data obtained by the document data obtaining unit; and
a response map rewriting unit that rewrites a response map, stored in the response map storing unit of the client which is set to communicate, into the response map generated by the response map generating unit; and
after the response map rewriting unit rewrites the response map, the display state rewriting unit starts to rewrite a display state of the display device.

7. The host-based information system according to claim 1, wherein the client receives electric power from a power supply of the host.

8. A client in a host-based information system composed of a plurality of clients and a host, each client comprising:
a storage-type display device adapted to hold a display state in a non-volatile manner;
a document storing unit that stores document data of a document displayed on the display device;
a plurality of client-side connection units that, when the host is connected, cause the client to communicate with the host and respectively correspond to predetermined processing; and
a response map storing unit that stores a response map indicating the predetermined processing corresponding to the client-side connection unit.

9. A host in a host-based information system composed of a plurality of clients and a host, the host comprising:
a host-side connection unit that connects the host to a predetermined position of the client so as to cause the client and host to communicate with each other;
a document data obtaining unit that obtains document data from the client, the document data being displayed on the display device of the client which is set to communicate; and
a processing executing unit that executes predetermined processing on the document data obtained by the document data obtaining unit, the predetermined processing being associated with the predetermined position, to which the host-side connection unit is connected.

10. An information system composed of a display terminal and a control device,
wherein the display terminal includes:
a storage-type display device adapted to hold a display state in a non-volatile manner;
a document storing unit that stores document data of a document displayed on the display device;
a display terminal-side connection unit that, when the control device is connected, causes the display terminal to communicate with the control device;
a display data storing unit that stores display data generated based on the document data; and
a display state rewriting unit that rewrites a display state of the display device based on the display data stored in the display data storing unit, and
the control device includes:
a control device-side connection unit adapted to connect the control device to the display terminal-side connection unit;
a document data obtaining unit that obtains document data from the document data storing unit, the document data being displayed on the display device of the display terminal which is set to communicate; and
a processing executing unit that generates display data based on the document data obtained by the document data obtaining unit and executes display data storage processing in which the display data is stored in the display data storing unit of the display terminal.

11. The information system according to claim 10, wherein:
the plurality of display terminal-side connection units are provided to respectively correspond to predetermined processing;
the display terminal includes a response map storing unit that stores a response map indicating the predetermined processing corresponding to the display terminal-side connection unit;
the response map includes the display data storage processing as the predetermined processing; and
the processing executing unit executes the predetermined processing on the document data obtained by the document data obtaining unit, the predetermined processing being associated with the display terminal-side connection unit, to which the control device-side connection unit is connected, by the response map.

12. A display terminal comprising:
a storage-type display device adapted to hold a display state in a non-volatile manner;
a document storing unit that stores document data of a document displayed on the display device;
a display terminal-side connection unit that, when a control device composing an information system along with said display terminal are connected, causes the control device and the display terminal to communicate with each other; and
a display state rewriting unit that rewrites a display state of the display device based on the display data stored in the display data storing unit.

13. A control device comprising:
a control device-side connection unit adapted to connect the control device to a predetermined position of a display terminal composing an information system along with said control device;
a document data obtaining unit that obtains document data of a document from the display terminal, the document being displayed on the display device of the display terminal which is set to communicate; and
a processing executing unit that generates display data based on the document data obtained by the document data obtaining unit and executes processing in which the display data is stored in the display terminal.
